(19) United States
(12) Patent Application Publication
(10) Pub. No.: US 2014/0337707 A1
(43) Pub. Date: Nov. 13, 2014

(54) METHOD AND APPARATUS FOR CLIENT TO BROWSE WEB PAGE PROVIDED BY SERVER

(71) Applicant: Samsung Electronics Co., Ltd., Suwon-si (KR)

(72) Inventor: Ryan Hyun CHOI, Suwon-si (KR)

(73) Assignee: Samsung Electronics Co., Ltd., Suwon-si (KR)

(21) Appl. No.: 14/264,710

(22) Filed: Apr. 29, 2014

(30) Foreign Application Priority Data
May 9, 2013 (KR) 10-2013-0052757

(51) Int. Cl. G06F 17/22

(52) U.S. Cl. CPC G06F 17/2247
USPC 715/234

(57) ABSTRACT

A method and an apparatus for browsing a web page in a client are provided. A hybrid Document Object Model (DOM) expressing some nodes with a binary array in a conventional DOM is generated by a server and is transferred to a client. Accordingly, the client need not directly generate a DOM of a complicated web page, and a decoding or parsing operation may be omitted with respect to a part of the DOM represented with a binary array. Hence, even mobile terminals having a small amount of resources may quickly browse a large and complicated web page.

### CROSS-REFERENCE TO RELATED APPLICATION(S)

This application claims the benefit under 35 U.S.C. §119(a) of a Korean patent application filed on May 9, 2013 in the Korean Intellectual Property Office and assigned Serial No. 10-2013-0052757, the entire disclosure of which is hereby incorporated by reference.

### TECHNICAL FIELD

The present disclosure relates to methods and apparatuses for browsing a web page in a client.

### BACKGROUND

Since a variety of web browsing devices, which are always connected to the Internet, allow users to access web pages with ease at any place, they provide a web experience for exploring an abundance of information.

FIG. 1 is a flowchart illustrating a process for a client to browse a web page provided by a server via a web browser according to the related art.

In operation 101, a client receives a web page file from a server via a URL.

In operation 102, the client decodes the web page file to generate a web page document. Since the web page file received in operation 101 consists of 0's and 1's is a binary format, binary-format data is decoded to generate a text-format web page document, for example, an html document.

In operation 103, the client parses the web page document to generate a Document Object Model (DOM). The DOM refers to an interface that allows a program or a script to dynamically access and update elements constituting the document, such as a style, a structure, and a content of the document. For example, an html DOM assumes that all elements constituting the html document are nodes of a tree structure, and provides an Application Programming Interface (API) that allows a script to access the respective nodes, modify the nodes, or add nodes. Accordingly, the generation of the DOM means that the elements of the web page are allocated with objects (nodes) of the tree structure.

In operation 104, the client adds Cascading Style Sheet (CSS) information to the DOM. CSS is a language that predefines the overall style of the web document, such as a font size, a font, and a color of the web document.

In operation 105, the client displays the web page by using the DOM. Specifically, a layout to be represented on a screen of the client, such as a position and a size of a box, is calculated using the DOM, and the calculated layout is rendered to a bitmap.

The size of the DOM is in proportion to the size and complexity of the web page. Thus, as the size and complexity of the web page increase, more resources are required when browsing the web page. In particular, in the case of mobile terminals, resources such as a memory size and CPU performance are limited to generating and processing a large DOM. Hence, it is difficult for users to smoothly browse various web pages through mobile terminals.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide methods and apparatuses for allowing a client to effectively browse a large-size web page having a complicated structure by utilizing a small amount of resources.

Additional aspects will be set forth in part in the detailed description which follows and, in part, will be apparent from the detailed description, or may be learned by practice of the various embodiments of the present disclosure.

In accordance with an aspect of the present disclosure, a method for browsing a web page in a client is provided. The method includes receiving a hybrid Document Object Model (DOM) from a server, the hybrid DOM including a binary part representing one or more DOM nodes with a binary array, and a tree part representing the one or more DOM nodes with a tree node, and displaying a web page represented by the hybrid DOM by performing traversal on the one or more DOM nodes represented with the binary part through bit counting with respect to the binary array.

The displaying of the web page may include navigating the one or more DOM nodes, which are to be accessed by a script that is executed by the client, through the bit counting with respect to the binary array.

The binary array may represent a tree structure of the one or more DOM nodes included in the binary part in a balanced parentheses representation scheme.

The displaying of the web page may include storing the binary array in a primary storage, and storing property information of the one or more DOM nodes included in the binary part in a secondary storage.

In accordance with another aspect of the present disclosure, a non-transitory computer readable medium storing a program is provided, which, when executed by a computer, performs the above-described method.

In accordance with another aspect of the present disclosure, a method for providing a web page from a server to a client is provided. The method includes generating a Document Object Model (DOM) representing web page elements with a tree structure, determining a part of the DOM representable with a binary array and a part of the DOM representable with a tree in the generated DOM, generating a hybrid DOM according to the determination, the hybrid DOM including a binary part representing one or more DOM nodes with a binary array, and a tree part representing the one or more DOM nodes with a tree node, and transmitting the hybrid DOM to a client that requests the web page.

The determining may be performed according to an execution of a script in the client, such that a part of a structure of the DOM nodes which is modified is represented with a tree, and another part of the structure of the DOM nodes may be represented with a binary array.

When resources usable for displaying the web page in the client decrease, the determining operation may increase a ratio of the part of the DOM representable with the binary array.

The method may further include: caching the generated hybrid DOM, and when a request for the web page is received from another client, transmitting the cached hybrid DOM to the another client.

The binary array may represent a tree structure of the one or more DOM nodes included in the binary part in a balanced parentheses representation scheme.

In accordance with another aspect of the present disclosure, a non-transitory computer readable medium storing a program is provided, which, when executed by a computer, performs the above-described method.

In accordance with another aspect of the present disclosure, a client apparatus for browsing a web page is provided. The client apparatus includes a receiving unit that receives a hybrid Document Object Model (DOM) from a server, the hybrid DOM including a binary part representing one or more DOM nodes with a binary array, and a tree part representing the one or more DOM nodes with a tree node, a control unit that performs traversal on the one or more DOM nodes represented with the binary part through bit counting with respect to the binary array, and a display unit that displays a web page represented by the hybrid DOM by using information acquired by the traversal.

The control unit may navigate the one or more DOM nodes, which are accessible by a script that is executed by the client apparatus, through the bit counting with respect to the binary array.

The binary array may represent a tree structure of the one or more DOM nodes included in the binary part in a balanced parentheses representation scheme.

The control unit may store the binary array in a primary storage, and store property information of the one or more DOM nodes included in the binary part in a secondary storage.

In accordance with another aspect of the present disclosure, a server apparatus for providing a web page to a client is provided. The server apparatus includes a DOM generation unit that generates a Document Object Model (DOM) representing web page elements with a tree structure, a determination unit that determines a part of the DOM representable with a binary array and a part of the DOM representable with a tree in the generated DOM, a hybrid DOM generation unit that generates a hybrid DOM according to the determination, the hybrid DOM including a binary part representing one or more DOM nodes with a binary array, and a tree part representing the one or more DOM nodes with a tree node, and a transmitting unit that transmits the hybrid DOM to a client that requests the web page.

The determination unit may perform determination according to an execution of a script in the client, such that a part of a structure of the DOM nodes which is modified is represented with a tree, and another part of the structure of the DOM nodes is represented with a binary array.

When resources usable for displaying the web page in the client decreases, the determination unit may increase a ratio of the part of the DOM representable with the binary array.

The server apparatus may further include a cache that stores the generated hybrid DOM, and when a request for the web page is received from another client, the transmitting unit may transmit the hybrid DOM stored in the cache to the another client.

The binary array may represent a tree structure of the one or more DOM nodes included in the binary part in a balanced parentheses representation scheme.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

These and/or other aspects will become apparent and more readily appreciated from the following description of the embodiments, taken in conjunction with the accompanying drawings of which:

FIG. 1 is a flowchart illustrating a process of browsing a web page in a client according to the related art;

FIG. 2 is a conceptual diagram describing a hybrid Document Object Model (DOM) according to an embodiment of the present disclosure;

FIG. 3 is a diagram describing a method for representing DOM nodes of a tree structure with a binary array according to an embodiment of the present disclosure;

FIG. 4 is a diagram illustrating a data structure of a binary part constituting the hybrid DOM according to an embodiment of the present disclosure;

FIG. 5 is a flowchart illustrating a process of providing a web page from a server to a client according to an embodiment of the present disclosure;

FIG. 6 is a flowchart illustrating a process of browsing a web page in a client according to an embodiment of the present disclosure;

FIGS. 7A, 7B, and 7C are diagrams describing a method for generating a hybrid DOM according to an embodiment of the present disclosure;

FIG. 8 is a diagram describing a method for representing a hybrid DOM according to an embodiment of the present disclosure; and

FIG. 9 is a diagram illustrating a structure of a server and a client according to an embodiment of the present disclosure.

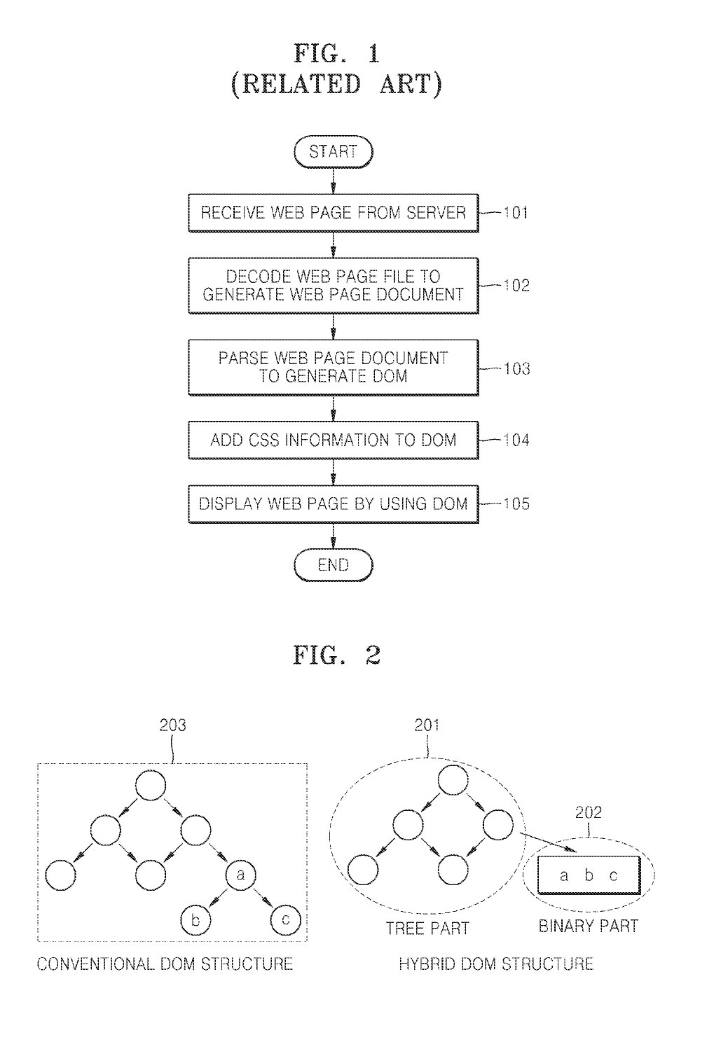

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

FIG. 2 is a conceptual diagram describing a hybrid Document Object Model (DOM) according to an embodiment of the present disclosure.

A hybrid DOM provided by improving a conventional DOM is proposed herein. The left side of FIG. 2 illustrates a conventional DOM structure 203, and the right side of FIG. 2 illustrates a proposed hybrid DOM structure. As described above, a client receives a text (for example, html) document from a server (web server or cloud server) and processes the received document to generate a DOM as illustrated on the left side of FIG. 2. That is, in the conventional DOM, all nodes are generated by parsing texts of a web page file, and the operation of parsing the texts and generating the DOM is performed by the client.

However, as illustrated on the right side of FIG. 2, all nodes in the hybrid DOM according to an embodiment of the present disclosure are not represented in a single manner. Specifically, the hybrid DOM according to an embodiment of the present disclosure classifies some nodes as a tree part 201 and the other nodes as a binary part 202 in the conventional DOM. While the tree part 201 is represented in the same manner as in the conventional DOM (for example, the tree part 201 is represented with html), and is transferred to the client, the binary part 202 represents the tree structure of the nodes with a binary array. Furthermore, the hybrid DOM according to an embodiment of the present disclosure is generated by the server and is transferred to the client.

According to an embodiment of the present disclosure, since the server represents elements belonging to some nodes of the conventional DOM with the binary array, the size of the web page file is reduced as compared with the related art. As a result, network traffic necessary for transferring the web page may be reduced.

In addition, the binary array need not be decoded or parsed, and node traversal or node navigation may be performed through bit counting with respect to DOM nodes represented with the binary array. Therefore, even a client having a small amount of resources may quickly browse a complicated or large-size web page.

Moreover, since the hybrid DOM is generated by the server and is transferred to the client, the client may entrust to the server the complicated operations such as computations necessary for generating the DOM, the execution of the script, and the like.

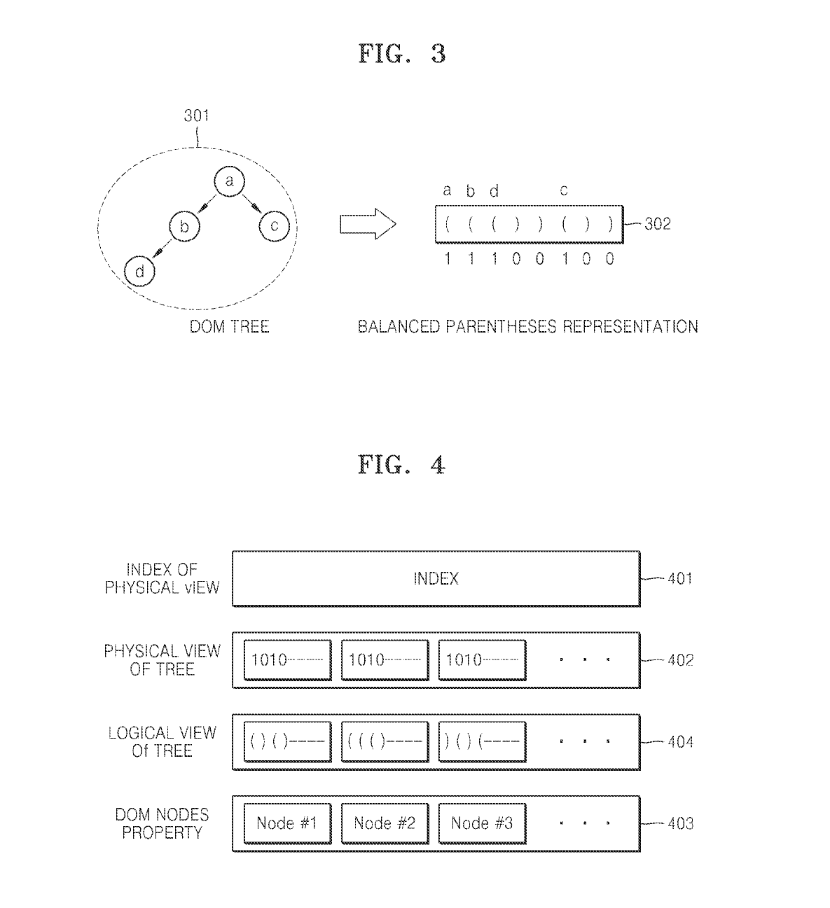

FIG. 3 is a diagram describing a method for representing DOM nodes of a tree structure with a binary array according to an embodiment of the present disclosure.

In this embodiment, it is assumed that a balanced parentheses representation scheme is used, but the method for representing the tree structure with the binary array is not specially limited.

The balanced parentheses representation scheme represents a node with parentheses. One node starts with “(” and ends with “)”, and parentheses of a child node are nested in parentheses of a parent node. Since “(” and “)” may be mapped to 1 and 0, the tree structure may be represented with the binary array.

As illustrated on the left side 301 of FIG. 3, it is assumed herein that the DOM includes four nodes a, b, c, and d, the nodes b and c are child nodes of the root node a, and the node d is a child node of the node b. In this case, the tree structure may be represented with 11100100 as illustrated on the right side 302 of FIG. 3.

FIG. 4 is a diagram illustrating a data structure of a binary part constituting a hybrid DOM according to an embodiment of the present disclosure.

As described above, the server according to an embodiment of the present disclosure generates a DOM, determines to represent some nodes with a binary array, and generates a binary part by using information about the corresponding nodes. The binary part generated in the above-described manner may be transferred to the client without a separate encoding or conversion process, and the client may perform node traversal or node navigation through bit counting alone by using the received binary part, without a decoding or parsing process.

The binary part may include a binary array 402 representing a structure, and a property 403 of each node. The node property 403 is information representing attributes of DOM nodes (for example, name, color, font, font size, CSS information, and the like). The client may perform traversal or navigation on the nodes by counting 1's and 0's of the binary array 402. Each box of the binary array 402 is a single memory block. Herein, each box of the binary array 402 is assumed as being an 8-bit memory block. “-” represents an empty space that is neither a 1 nor a 0, and it is reserved for a case where the DOM structure is updated. A logical view 404 represents the balanced parentheses scheme.

On the other hand, as the number of nodes increases, more time may be spent on bit counting. In this case, time necessary for accessing a particular node may be reduced using an index 401. The index 401 may be implemented in various manners. For example, the index 401 may represent how many 0's and 1's are included in memory blocks.

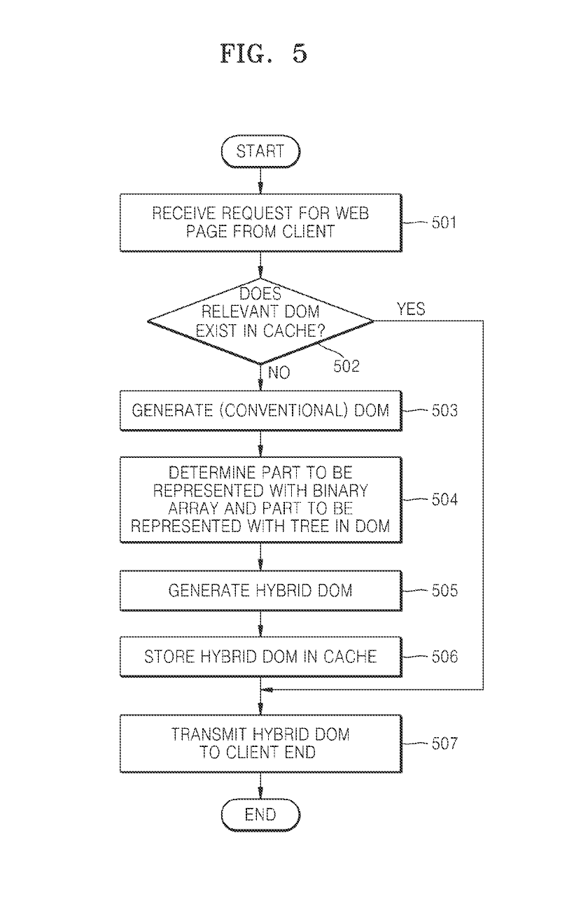

FIG. 5 is a flowchart illustrating a process of providing a web page from a server to a client according to an embodiment of the present disclosure.

In operation 501, a server receives from a client a request for a web page connected to a URL. This request may include resource information representing a client's memory, CPU, network bandwidth, OS type, and the like.

In operation 502, the server determines whether a (hybrid) DOM requested by the client is stored in a cache. When the requested DOM is stored in the cache (i.e. “YES”), the process proceeds to operation 507; otherwise (i.e. “NO”), the process proceeds to operation 503.

In operation 503, the server generates a DOM for a web page. The generated DOM is not the hybrid DOM proposed in an embodiment of the present disclosure, but the conventional DOM in which all nodes are represented with tree nodes. In order to generate the DOM, the server parses texts of the web page and executes scripts independent of the client, such as a CSS script, a Java script modifying the DOM structure, or the like. In the related art, since the DOM is generated by the client, the above operations are performed by the client. However, in an embodiment of the present disclosure, the server performs the above operations on behalf of the client. Therefore, the client may utilize sufficient resources of the server.

In operation 504, the server determines a binary part to be represented with the binary array and a tree part to be represented with the tree nodes among the DOM nodes. When the DOM nodes are represented with the binary array, the client may quickly perform node traversal or node navigation, but it is difficult to update the DOM structure. Whenever nodes are newly added or removed, a lot of bits need to all be shifted.

Generally, a function of providing interaction with a user by using a script in a web page is performed by DOM update. Therefore, if a part of the DOM node structure which is modified according to the execution of the script in the client is represented with the binary array, a web page browse speed may be lowered. Therefore, the part of the DOM node structure which is modified according to the execution of the script may be determined as the tree part, and the remaining part of the DOM node structure may be determined as the binary part. The server may parse a source code of a Java script to be executed in the client, and determine which part of the DOM is to be modified. For example, a part of the DOM node structure in which a menu bar is generated according to a position of a mouse on a web page may be determined as the tree part, and a new article part of the DOM node structure providing fixed content regardless of interaction with a user may be determined as the binary part.

On the other hand, resource information of the client, that is, the client's memory, CPU, network bandwidth, and OS type may be referenced as the criteria for determining the binary part and the tree part. In this case, as the resources usable for displaying the web page in the client are reduced, a ratio of the part to be represented with the binary array may be increased. For example, when the resources of the client are insufficient, a low-performance client may display a complicated web page in such a manner that even the part in which the DOM structure is modified according to interaction with a user on the web page is designated as the binary part.

In operation 505, the server generates the hybrid DOM according to the determination of operation 504.

In operation 506, the server stores the hybrid DOM in the cache.

In operation 507, the server transmits the hybrid DOM to the client.

After storing the hybrid DOM of the web page in the cache, the server may transmit the cached hybrid DOM in response to a request for the same web page from another client. Since such a caching is not essential, operations 502 and 506 may be omitted according to the server implementation method.

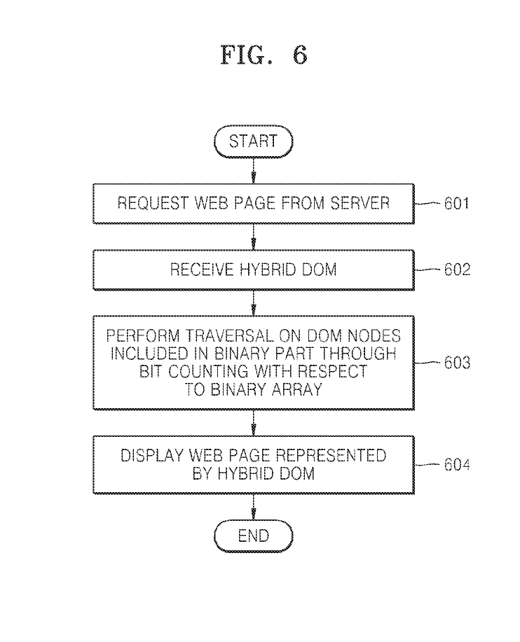

FIG. 6 is a flowchart illustrating a process of browsing a web page in a client according to an embodiment of the present disclosure.

In operation 601, a client requests a server to transmit a web page.

In operation 602, the client receives a hybrid DOM from the server. Specifically, the client recovers a part represented with a tree in the hybrid DOM generated in the server by receiving a web page file and decoding and parsing the tree part in the received web page file. However, since the binary part is directly extracted from the part included in the web page and connected to the tree node by the client, the client need not perform decoding or parsing on the binary part.

In operation 603, the client performs traversal on DOM nodes included in the binary part through bit counting with respect to the binary array in the hybrid DOM. The node traversal refers to acquisition of node information by accessing all nodes of the tree structure. The client needs to perform traversal on the DOM nodes in order to display the relevant web page.

In operation 604, the client displays the web page represented by the hybrid DOM. When it is necessary to access the particular DOM node in the script executed in the client, a node may be navigated by bit counting if the relevant node is included in the binary part. It is possible to implement navigation operators, such as nextChild( ) or firstChild( ), which the DOM API needs to provide through the bit counting with respect to the binary array. As a result, the hybrid DOM is compatible with the existing DOM.

As such, the client may perform traversal or navigation with respect to the nodes included in the binary part by the bit counting. When the index is used as described above, access time may be shortened. On the other hand, a conventional tree structure searching method (for example, depth first search) is used with respect to the nodes included in the tree part.

On the other hand, when storing the binary part of the hybrid DOM, the client may store the DOM node property information in a secondary storage (for example, HDD, SSD, or the like), and may store the other information in a primary storage (RAM). This is because the size of the DOM node property information is larger than that of the index or the binary array part.

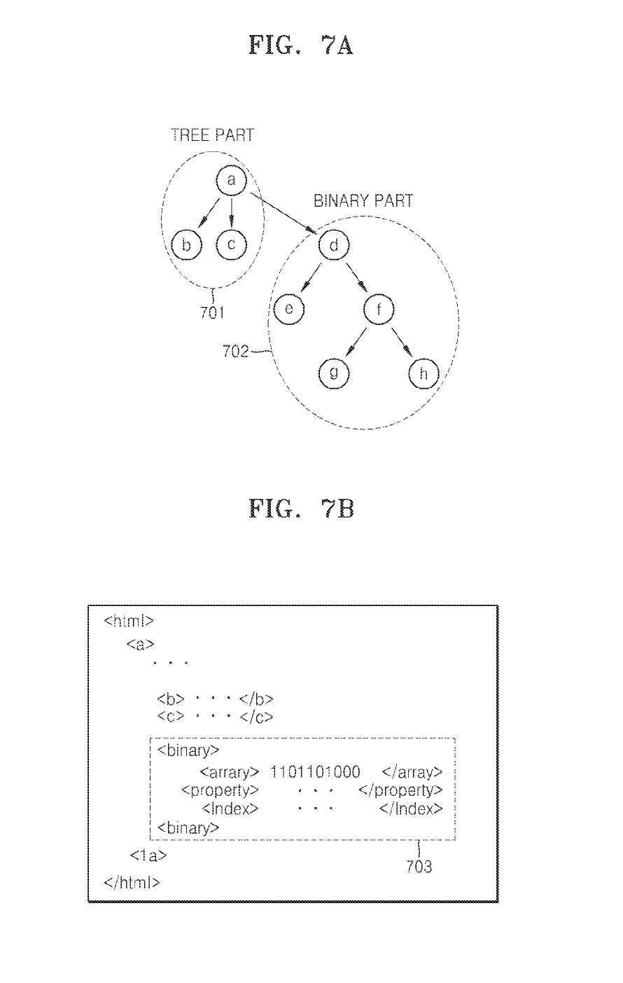

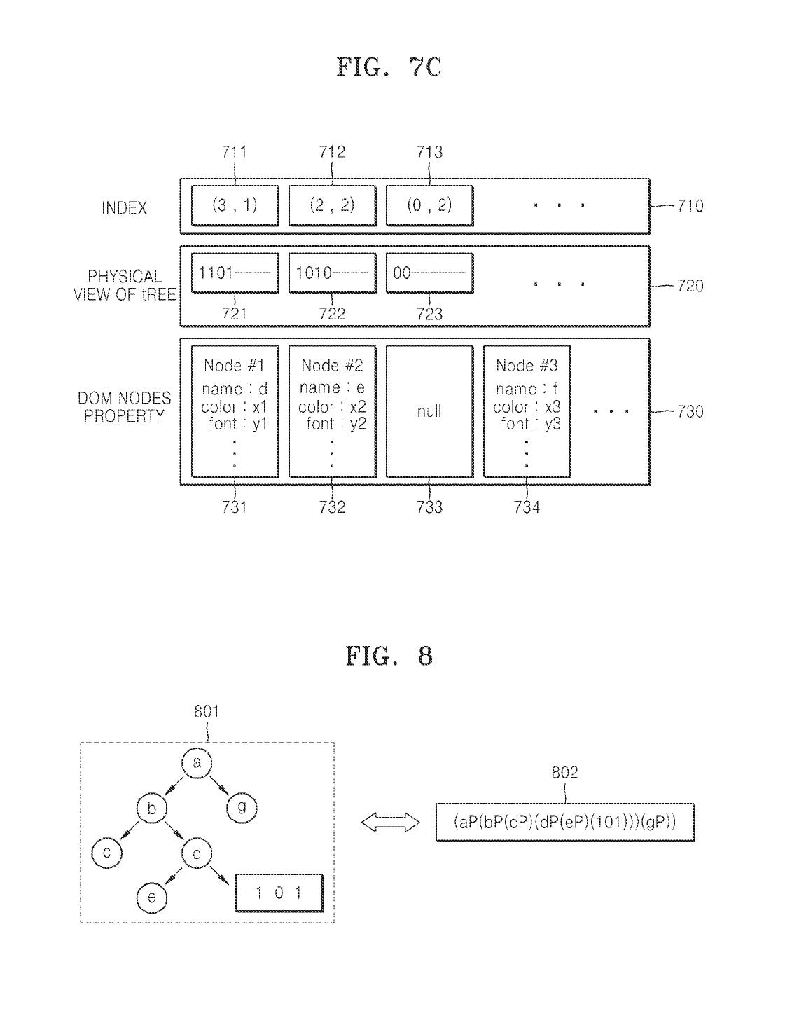

FIGS. 7A, 7B, and 7C are diagrams describing a method for generating a hybrid DOM according to an embodiment of the present disclosure.

FIG. 7A illustrates a conventional DOM structure representing a web page according to an embodiment of the present disclosure. As illustrated in FIG. 7A, the DOM generated by the server has eight nodes, and the server determines a part 701 constituted by nodes a, b and c as a tree part, and determines a part 702 constituted by nodes d, e, f, g and h as a binary part.

FIG. 7B illustrates an html document representing a hybrid DOM converted from the DOM of FIG. 7A. A dotted part 703 represents the binary part. Specifically, the tree structure of the five nodes d, e, f, g and h belonging to the binary part is represented with 1101101000 by the balanced parentheses representation scheme. Even though the document illustrated in FIG. 7B is encoded into a digital format in order for transmission via a network, the 1101101000 part does not change.

FIG. 7C illustrates a data structure of the binary part 702. As illustrated in FIG. 7C, the binary part 702 includes an index 710, a binary array 720 representing a tree structure, and property information 730 of DOM nodes.

The index 710 is information that is referenced for reducing a bit counting time as described above. A first index 711 shows that three 1's and one 0 are included in a first memory block 721 representing the tree structure of the nodes. A second index 712 shows that two 1's and two 0's are included in a second memory block 722 representing the tree structure of the nodes. A third index 713 shows that no 1 and two 0's are included in a third memory block 723 representing the tree structure of the nodes.

The binary array 720 representing the tree structure is allocated to the three memory blocks 721, 722 and 723. In this embodiment, an 8-bit memory block is assumed, and a part represented by “-” is an empty space that is prepared for a case where the DOM structure is updated

The property information 730 of the DOM nodes represents various attributes of the DOM nodes, for example, names, colors, and fonts of the DOM nodes. First property information 731 is property information of the node d represented by the first bit in the binary array. Second property information 732 is property information of the node e represented by the second bit in the binary array. The third property information 733 is information of the node represented by the third bit in the binary array. Since the third bit is 0, the third property information 733 represents no node. Therefore, the third property information 733 is an empty space. Fourth property information 734 is property information of the node f represented by the fourth bit in the binary array. For convenience, the property information of the nodes g and h is not illustrated.

FIG. 8 is a diagram describing a method for representing a hybrid DOM according to an embodiment of the present disclosure.

Only the case of representing the hybrid DOM with the html document has been described above. However, only if predefined between the client and the server, may the document generated for transferring the hybrid DOM be represented by various languages or syntaxes. For example, a hybrid DOM 801 illustrated on the left side of FIG. 8 may be represented briefly as illustrated on the right side 802 of FIG. 8. A part indicated by 101 in the hybrid DOM refers to the binary part, and P is used as representative meaning of the property information of each node.

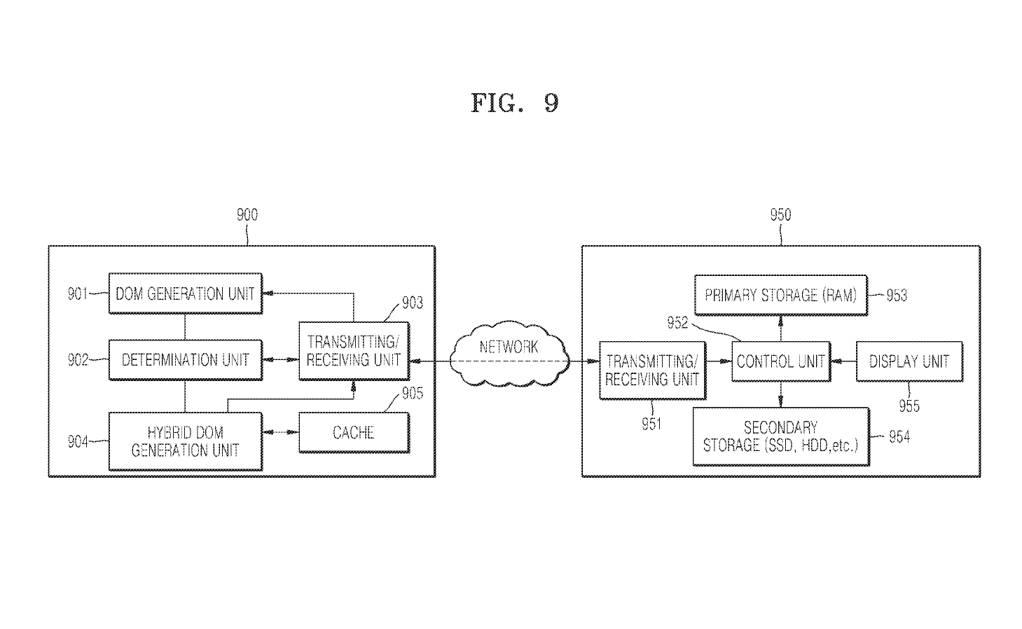

FIG. 9 is a diagram illustrating a structure of a server and a client according to an embodiment of the present disclosure.

Referring to FIG. 9, the server 900 according to an embodiment of the present disclosure includes a DOM generation unit 901, a determination unit 902, a transmitting/receiving unit 903, a hybrid DOM generation unit 904, and a cache 905.

The DOM generation unit 901 generates an existing conventional DOM representing web page elements with a tree structure. Specifically, the DOM generation unit 901 parses the web page and generates the web page DOM by performing scripts independent of the client 950, such as a CSS script, a Java script modifying the DOM structure, or the like.

The determination unit 902 determines a binary part to be represented with a binary array, and a tree part to be represented with a tree in the DOM generated by the DOM generation unit 901. As described above, a part of the DOM node structure which is modified by interaction with a user, that is, a part of the DOM structure which is modified by the script executed by the client, may be determined as the tree part, and the remaining part of the DOM structure may be determined as the binary part. In addition, as resources usable in the client 950 are reduced, a ratio of the binary part may be more increased.

The transmitting/receiving unit 903 receives a request for the web page from the client 950, and transmits the hybrid DOM to the client 950 in response to the request.

The hybrid DOM generation unit 904 generates the hybrid DOM according to the determination of the determination unit 902. The hybrid DOM includes the tree part and the binary part.

The cache 905 stores the hybrid DOM generated by the hybrid DOM generation unit 904. When receiving a request for the same web page from the same client 950 or another client (not illustrated), the server 900 transmits the hybrid DOM stored in the cache 905, without performing again the process of generating the hybrid DOM for the relevant web page.

On the other hand, the client 950 according to an embodiment of the present disclosure includes a transmitting/receiving unit 951, a control unit 952, a primary storage 953, a secondary storage 954, and a display unit 955.

The transmitting/receiving unit 951 sends a request for a web page to the server 900, and receives a hybrid DOM representing the relevant web page in response to the request.

The control unit 952 performs traversal on the DOM nodes represented with the binary part through bit counting with respect to the binary array, and navigates the DOM nodes to be accessed by the script that is executed by the client 950. In addition, the control unit 952 may store the binary part of the hybrid DOM separately in the primary storage 953 and the secondary storage 954. Specifically, property information of a large-capacity DOM node may be stored in the secondary storage 954, and the binary array representing the index or the tree structure of the nodes may be stored in the primary storage 953.

The display unit 955 displays the web page to the user by using information acquired by the control unit 952 through traversal and/or navigation of the DOM nodes.

In addition, other embodiments of the present disclosure can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present disclosure. The media may also be a distributed network, so that the computer readable code is stored/transferred and executed in a distributed fashion. Furthermore, the processing element could include a processor or a computer processor, and processing elements may be distributed and/or included in a single device.

It should be understood that the various embodiments described therein should be considered in a descriptive sense only and not for purposes of limitation. Descriptions of features or aspects within each embodiment should typically be considered as available for other similar features or aspects in other embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for browsing a web page in a client, comprising:
receiving a hybrid Document Object Model (DOM) from a server, the hybrid DOM comprising a binary part representing one or more DOM nodes with a binary array, and a tree part representing the one or more DOM nodes with a tree node; and
displaying the web page represented by the hybrid DOM by performing traversal on the one or more DOM nodes represented with the binary part through bit counting with respect to the binary array.

2. The method of claim 1, wherein the displaying of the web page comprises navigating the one or more DOM nodes, which are accessible by a script that is executed by the client, through the bit counting with respect to the binary array.

3. The method of claim 1, wherein the binary array represents a tree structure of the one or more DOM nodes included in the binary part in a balanced parentheses representation scheme.

4. The method of claim 1, wherein the displaying of the web page comprises storing the binary array in a primary storage, and storing property information of the one or more DOM nodes included in the binary part in a secondary storage.

5. A method for providing a web page from a server to a client, comprising:
generating a Document Object Model (DOM) representing web page elements with a tree structure;
determining a part of the DOM representable with a binary array and a part of the DOM representable with a tree in the generated DOM;
generating a hybrid DOM according to the determination, the hybrid DOM comprising a binary part representing one or more DOM nodes with a binary array, and a tree part representing the one or more DOM nodes with a tree node; and
transmitting the hybrid DOM to a client that requests the web page.

6. The method of claim 5, wherein the determining of the part of the DOM is performed according to an execution of a script in the client, such that a part of a structure of the DOM nodes which is modified is represented with a tree, and another part of the structure of the DOM nodes is represented with a binary array.

7. The method of claim 5, wherein when resources usable for displaying the web page in the client decrease, the determining operation increases a ratio of the part of the DOM representable with the binary array.

8. The method of claim 5, further comprising:
caching the generated hybrid DOM; and
when the request for the web page is received from another client, transmitting the cached hybrid DOM to the another client.

9. The method of claim 5, wherein the binary array represents the tree structure of the one or more DOM nodes included in the binary part in a balanced parentheses representation scheme.

10. A client apparatus for browsing a web page, comprising:
a receiving unit configured to receive a hybrid Document Object Model (DOM) from a server, the hybrid DOM comprising a binary part representing one or more DOM nodes with a binary array, and a tree part representing the one or more DOM nodes with a tree node;
a control unit configured to perform traversal on the one or more DOM nodes represented with the binary part through bit counting with respect to the binary array; and
a display unit configured to display a web page represented by the hybrid DOM by using information acquired by the traversal.

11. The client apparatus of claim 10, wherein the control unit is configured to navigate the one or more DOM nodes, which are accessible by a script that is executed by the client apparatus, through the bit counting with respect to the binary array.

12. The method of claim 5, wherein the binary array represents a tree structure of the one or more DOM nodes included in the binary part in a balanced parentheses representation scheme.

13. The client apparatus of claim 10, wherein the control unit stores the binary array in a primary storage, and stores property information of the one or more DOM nodes included in the binary part in a secondary storage.

14. A server apparatus for providing a web page to a client, comprising:
a DOM generation unit configured to generate a Document Object Model (DOM) representing web page elements with a tree structure;
a determination unit configured to determine a part of the DOM representable with a binary array and a part of the DOM representable with a tree in the generated DOM;
a hybrid DOM generation unit configured to generate a hybrid DOM according to the determination, the hybrid DOM comprising a binary part representing one or more DOM nodes with the binary array, and a tree part representing the one or more DOM nodes with the tree node; and
a transmitting unit configured to transmit the hybrid DOM to a client that requests the web page.

15. The server apparatus of claim 14, wherein the determination unit performs determination according to an execution of a script in the client, such that a part of a structure of the DOM nodes which is modified is represented with the tree, and another part of the structure of the DOM nodes is represented with the binary array.

16. The server apparatus of claim 14, wherein when resources usable for displaying the web page in the client decreases, the determination unit increases a ratio of the part of the DOM representable with the binary array.

17. The server apparatus of claim 14, further comprising a cache that stores the generated hybrid DOM, and
when a request for the web page is received from another client, the transmitting unit transmits the hybrid DOM stored in the cache to the another client.

18. The server apparatus of claim 14, wherein the binary array represents the tree structure of the one or more DOM nodes included in the binary part in a balanced parentheses representation scheme.

19. The server apparatus of claim 14, wherein the binary part representing one or more DOM nodes with the binary array is encoded as a digital representation in the hybrid DOM.

20. A non-transitory computer readable medium storing a program which, when executed by a computer, performs the method of claim 1.
